(19) United States
(12) Patent Application Publication
(10) Pub. No.: US 2013/0088637 A1
(43) Pub. Date: Apr. 11, 2013

(54) Lens Stack Arrays Including Adaptive Optical Elements

(71) Applicant: Pelican Imaging Corporation, Mountain View, CA (US)

(72) Inventor: Jacques Duparre, Jena (DE)

(73) Assignee: Pelican Imaging Corporation, Mountain View, CA (US)

(21) Appl. No.: 13/650,039

(22) Filed: Oct. 11, 2012

Related U.S. Application Data
(60) Provisional application No. 61/545,929, filed on Oct. 11, 2011.

(51) Int. Cl. H04N 5/225

(52) U.S. Cl. 348/360; 348/E05.024

(57) ABSTRACT

Systems and methods in accordance with embodiments of the invention incorporate adaptive optical elements into optical channels in a lens stack array. In one embodiment, an array camera module includes a lens stack array, that includes at least two lens stacks, where at least one lens stack includes an adaptive optical element that can adjust the characteristics of the transmission of light in the optical channel defined by the corresponding lens stack in response to at least one electrical signal, a sensor including a focal plane for each lens stack within the lens stack array, and circuitry configured to control at least one adaptive optical element, where the lens stack array and the sensor are configured so that each lens stack can form an image on a corresponding focal plane.

### CROSS-REFERENCE TO RELATED APPLICATIONS

This application claims priority to U.S. Provisional Patent Application No. 61/545,929 entitled “Lens Stack Arrays Including Adaptive Optical Elements” filed on Oct. 11, 2011, the disclosure of which is incorporated by reference herein in its entirety.

### FIELD OF THE INVENTION

The present invention relates to lens stack arrays and more specifically to lens stack arrays that include adaptive optical elements.

### BACKGROUND

In response to the constraints placed upon a traditional digital camera based upon the camera obscura, a new class of cameras that can be referred to as array cameras has been proposed. Array cameras are characterized in that they include multiple arrays of pixels, each pixel array typically intended to define a focal plane (a focal plane may alternatively be referred to as a ‘focal plane array’), and each focal plane typically being associated with a separate lens system. In many instances, the array camera is constructed using a sensor that incorporates multiple focal planes and a lens stack array. Each lens stack typically includes one or more lenses, and additional components including (but not limited to) diaphragms, filters, substrates and (opaque) spacers.

### SUMMARY OF THE INVENTION

Systems and methods in accordance with embodiments of the invention incorporate adaptive optical elements into optical channels in a lens stack array. In accordance with one embodiment, an array camera module includes a lens stack array, that includes at least two lens stacks, where at least one lens stack includes an adaptive optical element that can adjust the characteristics of the transmission of light in the optical channel defined by the corresponding lens stack in response to at least one electrical signal, a sensor including a focal plane for each lens stack within the lens stack array, where each focal plane comprises a plurality of rows of pixels that also form a plurality of columns of pixels and each focal plane is contained within a region of the sensor that does not contain pixels from another focal plane, and circuitry configured to control at least one adaptive optical element, where the lens stack array and the sensor are configured so that each lens stack can form an image on a corresponding focal plane.

In another embodiment, the array camera module further includes circuitry to control at least one adaptive optical element based on at least one electrical signal generated by the sensor.

In still another embodiment, each of the lens stacks within the lens stack array includes at least one adaptive optical element.

In another embodiment, at least one of the adaptive optical elements is configured to adjust the focal length of its corresponding lens stack.

In yet another embodiment, the at least one adaptive optical element is configured to adjust the focal length of its corresponding lens stack so that its focal length is aligned with its corresponding focal plane.

In a further embodiment, the at least one adaptive optical element that is configured to adjust the focal length of its corresponding lens stack, includes at least one piezo element, where the activation of the at least one piezo element causes the adaptive optical element to adjust the focal length of its corresponding lens stack.

In yet another embodiment, the at least one adaptive optical element that is configured to adjust the focal length of its corresponding lens stack, also includes a glass support, a polymer layer, and a thin glass membrane, where the glass support is disposed adjacent to one side of the polymer layer, and the thin glass membrane is disposed adjacent to a second opposite side of the polymer layer, and where the at least one piezo element is coupled to the glass membrane such that activation of the piezo element deflects the thin glass membrane such that the focal length of the corresponding lens stack is controllably adjusted.

In another embodiment, the adaptive optical element includes a liquid crystal layer that includes liquid crystal elements.

In still another embodiment, the adaptive optical element also includes a first glass substrate, a second glass substrate, a third glass substrate, a first electrode, a second electrode, and a shaping layer, where the shaping layer includes two different materials that have the same refractive index, but different dielectric properties, where the first electrode is disposed adjacent to and in between the first glass substrate and the liquid crystal layer, where the liquid crystal layer is disposed adjacent to and in between the first electrode and the second glass substrate, where the second glass substrate is disposed adjacent to and in between the liquid crystal layer and the shaping layer, where the shaping layer is disposed adjacent to and in between the second glass substrate and the second electrode, where the second electrode is disposed adjacent to and in between the shaping layer and the third glass substrate, and where when a potential difference is applied across the first electrode and the second electrode, the potential difference causes a differential rotation of the liquid crystal elements so as to adjust the lens stack's focal length.

In another embodiment, the adaptive optical element includes a plurality of electrodes, configured to generate an electric field, the magnitude of which varies as a function of the radial position with respect to the corresponding lens stack.

In yet another embodiment, the adaptive optical element is configured to adjust focal length by varying its thickness.

In still another embodiment, the adaptive optical element is configured to adjust image position by varying the axial position of at least one lens element within a respective lens stack.

In another embodiment, the adaptive optical element includes at least one MEMS-based actuator for varying the axial position of at least one lens element within a respective stack.

In still another embodiment, the adaptive optical element is further configured to magnify an image.

In yet another embodiment the adaptive optical element includes at least one VCM for varying the axial position of at least one lens element within a respective lens stack.

In a further embodiment, at least one of the adaptive optical elements is configured to adjust the central viewing angle of its corresponding lens stack.

In still a further embodiment, the at least one adaptive optical element is configured to adjust the central viewing angle of its corresponding lens stack so as to increase the angular sampling of the images diversity provided by the focal plane.

In yet still a further embodiment, at least one adaptive optical element includes a plurality of electrodes that are configured to control the centration of the refractive power distribution of the adaptive optical element.

In still another embodiment, the electrodes are arranged in an azimuthally segmented pattern such that a potential difference may be selectively applied across a subset of the electrodes thereby controlling the centration of the refractive power distribution of the adaptive optical element.

In yet another embodiment, the extent of the adjustment of the central viewing angle is based on the distance of the object, relative to the camera, the image of which the focal planes are capturing.

In another embodiment at least one of the adaptive optical elements is configured to provide color adaptation capabilities.

In yet another embodiment, at least one adaptive optical element is configured to provide color-specific focusing.

In still another embodiment, all of the adaptive optical elements provide for color specific focusing, where the colors that are specifically focused are one of either red, blue, or green, and where the adaptive optical elements with color-specific focusing are configured to implement π filter groups on the lens stack array.

In another embodiment, an array camera module includes at least one measuring device configured to measure at least one physical parameter, where the circuitry is configured to control at least one adaptive optical element based on the at least one physical parameter measured by the measuring device.

In still yet another embodiment, at least one adaptive optical element includes at least one measuring device that is configured to measure temperature and generate at least one electrical signal indicative of the temperature measurement, and the circuitry is configured to control the adaptive optical element based on the at least one electrical signal indicative of the temperature measurement generated by the at least one measuring device.

In a further embodiment, the circuitry is configured to control the at least one adaptive optical element based on at least one electrical signal generated by a controller.

In another embodiment, an array camera module includes a lens stack array that includes at least two lens stacks, where each lens stack includes an adaptive optical element that can adjust the characteristics of the transmission of light in the optical channel defined by the corresponding lens stack in response to an electrical signal and each adaptive optical element includes a liquid crystal layer and a plurality of electrodes that can generate an electric field, the magnitude of which varies as a function of radial and circumferential position with respect to the lens stack, such that the lens stack's focal length and central viewing direction can be adjusted, a sensor including a focal plane for each lens stack within the lens stack array, where each focal plane comprises a plurality of rows of pixels that also form a plurality of columns of pixels and each focal plane is contained within a region of the sensor that does not contain pixels from another focal plane, and circuitry configured to control at least one adaptive optical element based on at least one electrical signal generated by the sensor, where the lens stack array and the sensor are configured so that each lens stack can form an image on a corresponding focal plane.

### BRIEF DESCRIPTION OF THE DRAWINGS

FIG. 1 illustrates an array camera including an array camera module.

FIG. 2 conceptually illustrates an array camera module in accordance with an embodiment of the invention.

FIG. 3 illustrates an array camera module that employs a π filter group in accordance with an embodiment of the invention.

FIG. 4A conceptually illustrates variations in focal length that can occur in a conventional lens stack array.

FIG. 4B conceptually illustrates an array camera module in which the lens stack array incorporates adaptive optical elements in accordance with an embodiment of the invention.

FIG. 5A illustrates an adaptive optical element that comprises a glass support, a polymer, a glass membrane and piezo elements in accordance with an embodiment of the invention.

FIG. 5B illustrates the operation of an adaptive optical element that comprises a glass support, a polymer, a glass membrane and piezo elements in accordance with an embodiment of the invention

FIG. 6 is a cross-sectional view of a liquid crystal adaptive optical element that can be utilized in a lens stack array in accordance with an embodiment of the invention.

FIGS. 7A and 7B conceptually illustrate the increase in refractive power that can be achieved by increasing the voltage applied to the electrodes of an adaptive optical element.

FIG. 8 illustrates an adaptive optical element that is capable of varying its thickness to adjust focal distance

FIG. 9 conceptually illustrates a shift in the centration of the refractive power distribution of an adaptive optical element in accordance with an embodiment of the invention.

FIGS. 10A and 10B conceptually illustrate electrode configurations to which voltages can be selectively applied to alter the centration of the refractive power distribution of an adaptive optical element in accordance with embodiments of the invention.

FIG. 11A conceptually illustrates a set of electrodes that can be utilized in an adaptive optical element to generate a radially varying electric field to control the refractive power distribution of the adaptive optical element in accordance with an embodiment of the invention.

FIG. 11B conceptually illustrates an electrode configuration that can be configured to laterally shift the electric field generated by an adaptive optical element in accordance with an embodiment of the invention.

### DETAILED DESCRIPTION

Turning now to the drawings, systems and methods for incorporating adaptive optical elements into optical channels of a lens stack array in accordance with embodiments of the invention are illustrated. Adaptive optical elements can adjust the characteristics of the transmission of light in an optical channel in response to an electrical signal. In U.S. patent application Ser. No. 12/935,504, entitled “Capturing and Processing of Images Using Monolithic Camera Array with Heterogeneous Imagers”, Venkataraman et al. describe processes for constructing array cameras using lens stack arrays. The disclosure of U.S. patent application Ser. No. 12/935,504 is incorporated by reference herein in its entirety. An array camera module is typically intended to be constructed in such a way that a monolithic sensor, including a focal plane (i.e. an array of pixels configured to capture an image formed on it by a corresponding lens stack) for each of the array camera module's optical channels (the optical channel being defined by the corresponding lens stack), and a lens stack array are located with respect to each other so that each focal plane is positioned at the focal distance of its corresponding lens stack in each optical channel. Focal planes typically include a plurality of rows of pixels that also form a plurality of columns of pixels, and each focal plane is typically contained within a region of the sensor that does not contain pixels from another focal plane. The lens stack array may be rigid such that the individual lens stacks within the array cannot move relative to one another. The combination of a lens stack and its corresponding focal plane can be understood to be a ‘camera module.’

Ideally, the lens stack array of an array camera is constructed so that each lens stack has the same focal length. However, the large number of tolerances involved in the manufacture of a lens stack array can result in the lens stacks having parameters—such as focal length—that deviate from the nominal prescription. Due to the monolithic nature of the sensor, it typically cannot be placed a distance that corresponds with the focal length of each lens stack within a rigid lens stack array. Therefore, manufacturing variations between the lens stacks can result in some or all of the images formed by the optical channels being out of focus. Notably, these manufacturing variations may result in different focal lengths even as between lens stack arrays fabricated from the same manufacturing process. In addition, other manufacturing tolerances associated with the assembly of the array camera module including (but not limited to) variations in spacer thickness and alignment of the lens stack array relative to the sensor can impact all of the optical channels.

In U.S. Provisional Patent Application No. 61/666,852, entitled “Systems and Methods for Manufacturing Camera Modules Using Active Alignment of Lens Stack Arrays and Sensors,” Duparre et al. describe solutions including aligning the lens stack arrays with the sensors so as to lessen the detrimental impact that result from the variations in lens parameters. The disclosure of U.S. Patent Application Ser. No. 61/666,852 is incorporated by reference herein in its entirety.

In many embodiments of the instant invention, lens stack arrays are utilized that incorporate adaptive optical elements with variable refractive power that can modify the focal length of the lens stack. When a lens stack array that includes adaptive optical elements is incorporated into an array camera module, the adaptive optical elements can be controlled to calibrate the focal length of each lens stack for the image distance to correspond to the distance between the lens stack and the corresponding focal plane on the sensor. In several embodiments, the adaptive optical elements are calibrated to reduce the defocus in each optical channel using a reference image. Incorporating adaptive optical elements into lens stacks may provide for a cost-effective solution for lessening the detrimental impact that results from the variation in lens parameters, as compared with the solutions provided in U.S. Patent Application Ser. No. 61/666,852. Specifically, the incorporation of adaptive optical lenses may negate the need to employ a rigorous active alignment process like that disclosed in U.S. Patent Application Ser. No. 61/666,852. In addition, adaptive elements can enhance the results achieved within a camera module manufactured using any alignment process (including active alignment processes).

Moreover, the adaptive optical element can be used to shift the centration of the refractive power distribution of the adaptive optical element. In this way, the adaptive optical elements can be utilized to increase the sampling diversity between the images captured by each focal plane on a sensor. As is disclosed in U.S. patent application Ser. No. 12/967,807 entitled “System and Methods for Synthesizing High Resolution Images Using Super-Resolution Processing”, to Lelescu et al., increasing sampling diversity can improve the increase in resolution achieved using super resolution (SR) processing when synthesizing a high resolution image from multiple images captured by an array camera. The disclosure of U.S. patent application Ser. No. 12/967,807 is incorporated by reference herein in its entirety.

In several embodiments, adaptive optical elements are used to adjust lens stacks in other ways. For example, in many embodiments, adaptive optical elements may be used to provide color adaptation. In a number of embodiments, the adaptive optical elements can be used to accommodate thermal variation of the optical stack. In several embodiments, dark current measurements are utilized to measure temperature and the adaptive optical elements varied accordingly.

In numerous embodiments, multiple images of a scene are rapidly captured while adjusting the focal lengths of one or more of the lens stacks using adaptive elements. In this way, a processor can select images according to criteria including but not limited to focus prior to performing processing such as (but not limited to) super resolution processing to synthesize a higher resolution image.

Array cameras, lens stack arrays, and adaptive optical elements in accordance with embodiments of the invention are discussed further below.

### Array Camera Architecture

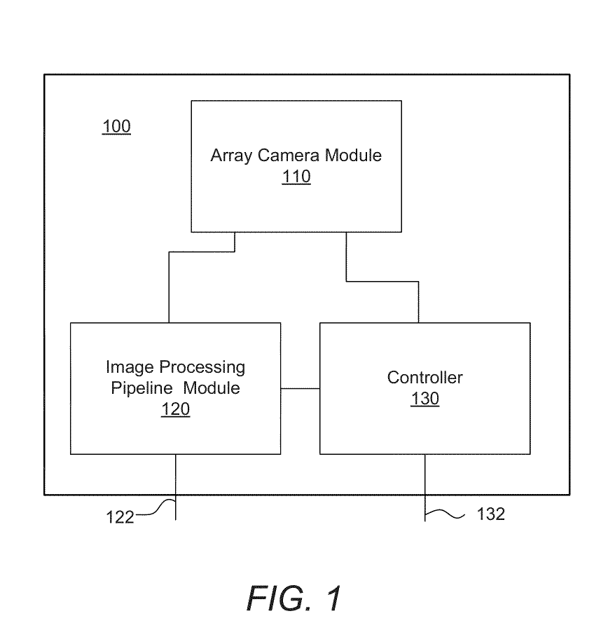

An array camera architecture that can be used in a variety of array camera configurations in accordance with embodiments of the invention is illustrated in FIG. 1. The array camera 100 includes an array camera module 110, which is connected to an image processing pipeline module 120 and to a controller 130.

The array camera module includes two or more focal planes, each of which receives light through a separate lens stack. The array camera module can also include other circuitry to control imaging parameters and measuring devices to measure physical parameters and generate corresponding signals. In many embodiments, an array camera module includes circuitry to control the array camera module's adaptive optical elements. In a number of embodiments, the circuitry is configured to communicate with a device, e.g. via the generation and transmission of signals, and control the adaptive optical elements based upon this communication. In numerous embodiments, the circuitry communicates with the sensor, and controls the adaptive optical elements based on this communication. In several embodiments, the circuitry communicates with the controller, and controls the adaptive optical elements based on this communication. The sensor or the controller may transmit signals to the circuitry based upon signals generated by measuring devices. The control circuitry can also control imaging parameters such as exposure times, gain, and black level offset. In one embodiment, the circuitry for controlling imaging parameters may trigger the capture of images by each focal plane independently or in a synchronized manner. The array camera module can include a variety of other measuring devices, including but not limited to, dark pixels to estimate dark current at the operating temperature. Array camera modules that can be utilized in array cameras in accordance with embodiments of the invention are disclosed in U.S. patent application Ser. No. 12/935,504, entitled “Capturing and Processing of Images Using Monolithic Camera Array with Heterogeneous Imagers”, to Venkataraman et al.

The image processing pipeline module 120 is hardware, firmware, software, or a combination for processing the images received from the array camera module 110. The image processing pipeline module 120 processes the multiple images captured by the focal planes in the array camera module and produces a synthesized higher resolution image. In a number of embodiments, the image processing pipeline module 120 provides the synthesized image data via an output 122.

The controller 130 is hardware, software, firmware, or a combination thereof for controlling various operational parameters of the array camera module 110. The controller 130 receives inputs 132 from a user or other external components and sends operation signals to control the array camera module 110. The controller 130 can also send information to the image processing pipeline module 120 to assist processing of the images captured by the focal planes in the array camera module 110.

Although a specific array camera architecture is illustrated in FIG. 1, alternative architectures that enable the capturing of images and application of SR processes to produce a synthesized high resolution image can also be utilized in accordance with embodiments of the invention. The use of adaptive optical elements in array camera modules in accordance with embodiments of the invention is discussed further below.

### Array Camera Modules

Array camera modules in accordance with many embodiments of the invention include the combination of a lens stack array and a monolithic sensor that includes an array of focal planes. The lens stack array includes an array of lens stacks, where each lens stack defines a separate optical channel. The lens stack array is mounted to a monolithic sensor that includes a focal plane for each of the optical channels, where each focal plane includes an array of pixels or sensor elements configured to capture an image. When the lens stack array and the sensor including the array of focal planes are combined with sufficient precision, the array camera module can be utilized to capture multiple images of a scene that can be passed to an image processing pipeline to synthesize a high resolution image using SR processing.

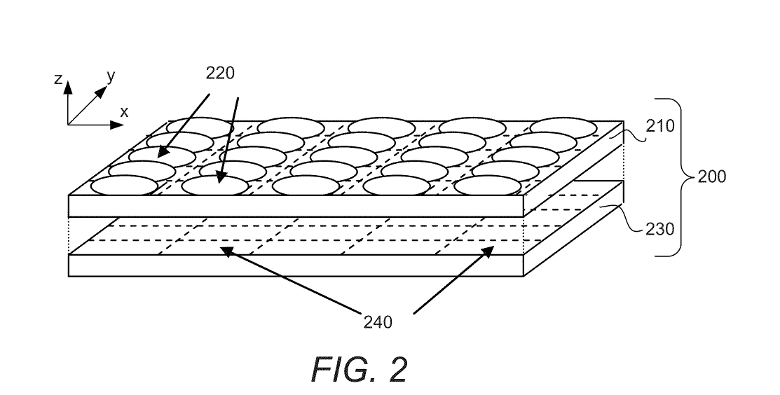

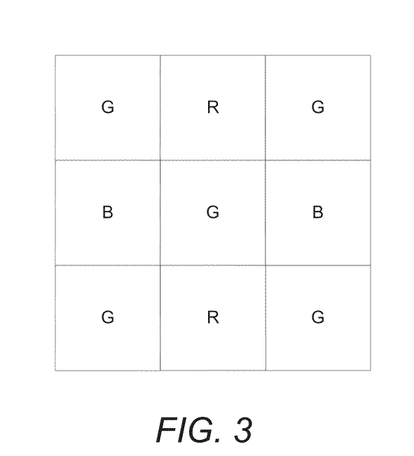

An exploded view of an array camera module formed by combining a lens stack array with a monolithic sensor including an array of focal planes in accordance with an embodiment of the invention is illustrated in FIG. 2. The array camera module 200 includes a lens stack array 210 and a sensor 230 that includes an array of focal planes 240. The lens stack array 210 includes an array of lens stacks 220. Each lens stack 220 creates an optical channel that resolves an image on one of the focal planes 240 on the sensor 230. Each of the lens stacks 220 may be of a different type. In several embodiments, the optical channels are used to capture images of different portions of the wavelength of light spectrum and the lens stack in each optical channel is specifically optimized for the portion of the spectrum imaged by the focal plane associated with the optical channel. More specifically, an array camera module may be patterned with “π filter groups.” The term π filter groups refers to a pattern of color filters applied to the lens stack array or the focal planes of an array camera module, and processes for patterning array cameras with π filter groups are described in U.S. Patent Application Ser. No. 61/641,164, entitled “Camera Modules Patterned with π filter groups”, by Venkataraman et al. The disclosure of U.S. Patent Application Ser. No. 61/641,164 is incorporated by reference herein in its entirety. FIG. 3 illustrates a single π filter group, wherein 5 cameras are configured to receive green light, 2 cameras are configured to receive red light, and 2 cameras are configured to receive blue light.

In many embodiments, the array camera module 230 includes lens stacks 220 having one or multiple separate optical lens elements axially arranged with respect to each other. As is discussed further below, lens stack arrays 210 in accordance with several embodiments of the invention include one or more adaptive optical elements that can enable the independent adjustment of the focal length of each lens stack and/or later shifting of the centration of the refractive power distribution of the adaptive optical element.

In several embodiments, the array camera module employs wafer level optics (WLO) technology. WLO is a technology that encompasses a number of processes, including, for example, molding of lens arrays on glass wafers, stacking of those wafers (including wafers having lenses replicated on either side of the substrate) with appropriate spacers, followed by packaging of the optics directly with the imager into a monolithic integrated module.

The WLO procedure may involve, among other procedures, using a diamond-turned mold to create each plastic lens element on a glass substrate. More specifically, the process chain in WLO generally includes producing a diamond turned lens master (both on an individual and array level), then producing a negative mould for replication of that master (also called a stamp or tool), and then finally forming a polymer replica on a glass substrate, which has been structured with appropriate supporting optical elements, such as, for example, apertures (transparent openings in light blocking material layers), and filters.

Although the construction of lens stack arrays using WLO is discussed above, any of a variety of techniques can be used to construct lens stack arrays, for instance those involving precision glass molding, polymer injection molding or wafer level polymer monolithic lens processes. The construction of lens stack arrays including adaptive optical elements in accordance with embodiments of the invention is discussed further below.

### Lens Stack Arrays

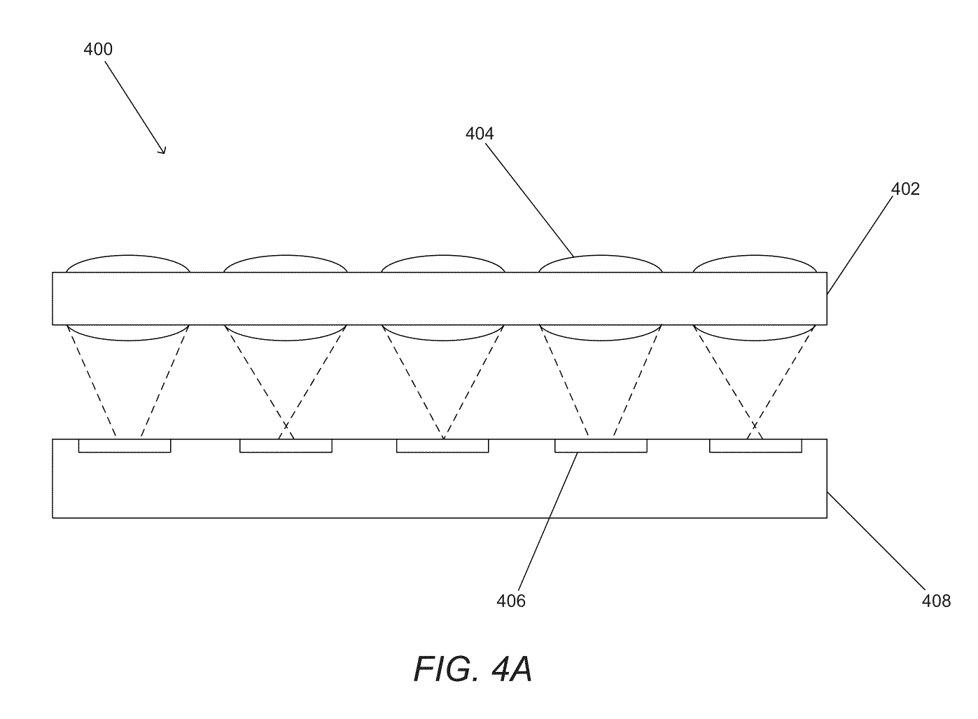

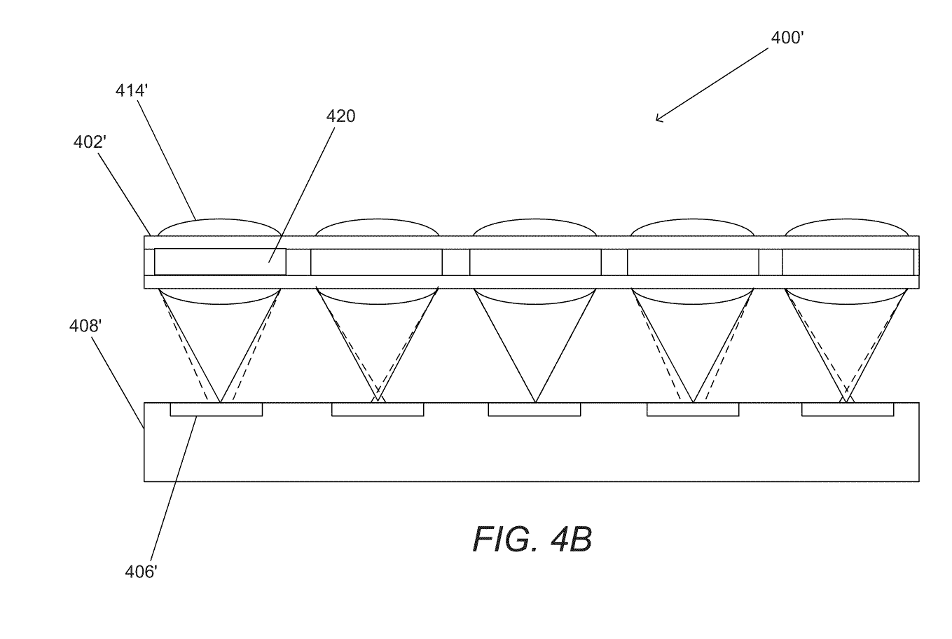

Manufacturing tolerances result in the fabrication of lens stack arrays that vary from the original prescription. The variations in focal length that can occur in a conventional lens stack array are conceptually illustrated in FIG. 4A. The array camera module 400 includes a lens stack array 402 in which lens stacks focus light on the focal planes 406 of a sensor 408. As is illustrated, variance between the actually fabricated lens stack and its original prescription can result in the lens stack having a focal length that varies slightly from its prescription and consequently an image distance that does not correspond with the distance between the lens stack array and the sensor. Accordingly, the images formed on the focal planes of the sensor can be out of focus. In many embodiments of the invention, array camera modules are utilized to capture images that are provided to an image processing pipeline to synthesize a high resolution image using SR processing. When the images captured by the array camera module are out of focus, the increase in resolution gain that can be achieved using SR processing can be impacted.

In numerous embodiments, multiple images of a scene are rapidly captured while adjusting the focal lengths of one or more of the lens stacks using adaptive elements. In this way, a processor can select images according to criteria including but not limited to focus prior to performing processing such as (but not limited to) super resolution processing to synthesize a higher resolution image.

In a number of embodiments of the invention, adaptive optical elements are incorporated into at least one lens stack to enable the adjustment of its respective focal length. In this way, the refractive power of the adaptive optical elements can be controlled to reduce the defocus of the images formed on the array of focal planes on the sensor by the lens stacks. An array camera module in which the lens stack array incorporates adaptive optical elements in accordance with an embodiment of the invention is conceptually illustrated in FIG. 4B. The lens stack array 402′ includes at least one adaptive optical element 420 in each of the lens stacks 414′. The focal length of each of the lens stacks in the absence of intervention by the adaptive optical element is shown using dashed lines. In operation, a reference pattern can be utilized to determine the defocus in each of the optical channels and appropriate controls can be applied to the adaptive optical elements to modify the focal length of each of the lens stacks.

In many embodiments, the adaptive optical elements are optical components in the lens stack that can controllably modify their refractive power. In numerous embodiments, adaptive optical elements that can controllably modify refractive power are placed closest to the aperture and furthest from the sensor relative to other elements/lenses in a respective lens stack. In several embodiments, modification of the refractive power of the adaptive optical element is achieved mechanically including (but not limited to) microelectromechanical systems (MEMS), active polymer actuators, and/or liquid lenses. In a number of embodiments, the MEMS system comprises a thin glass membrane separated from a glass support by a polymer, where piezo elements apply forces to the glass membrane. In several embodiments, the piezo elements include piezo rings that force the glass membrane to bend and generate optical power variation.

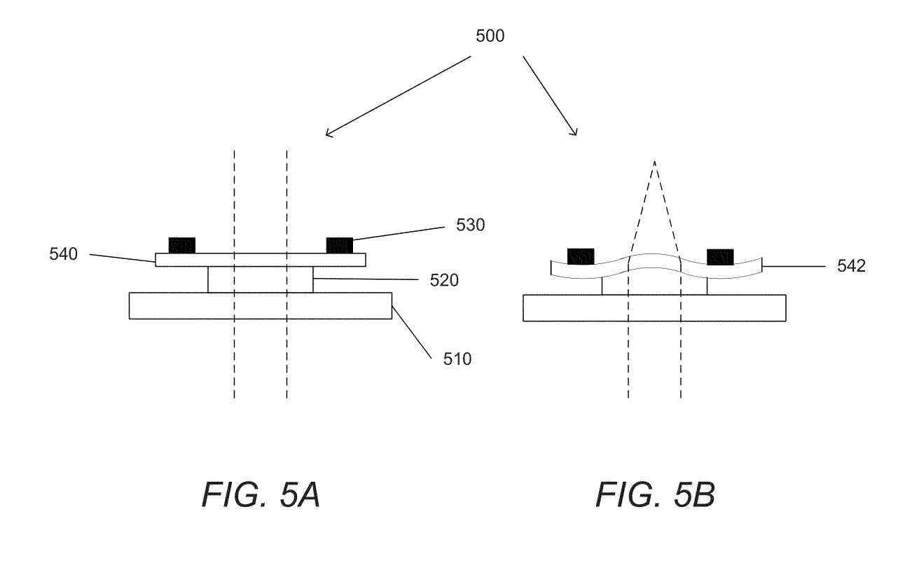

A MEMS system that comprises a thin glass membrane, a polymer, glass support, and piezo elements in accordance with an embodiment of the invention is illustrated in FIGS. 5A and 5B. The MEMS system 500 includes a glass support 510 that supports a polymer 520, which supports a glass membrane 540. The glass membrane is coupled to piezo elements 530. As shown in FIG. 5A, when the piezo elements 530 are not subject to a voltage, light rays (indicated by the dashed lines) pass through the MEMS system unperturbed. However, as shown in FIG. 5B, when the piezo elements 530 are activated, the activation causes the glass membrane to deflect 542, and the deflection augments light rays that pass through the MEMS system, thereby adjusting the focal length. The extent of the activation of the piezo elements controls the extent of the deflection, which in turn is correlated with the adjustment of the focal length. Thus, the focal length can be manipulated by controlling the extent of the activation piezo elements.

In a number of embodiments of the invention, modification of the refractive power of the adaptive optical element is achieved using mechanically static components (i.e. components that do not (macroscopically) move) including, but not limited to, components that apply shaped electric fields to modify the refractive power of a layer of liquid crystals. In several embodiments, static components in which liquid crystals are contained between glass substrates are utilized in the construction of the lens stack array and the glass substrates are utilized as the basis for the further replication of the lens stack array.

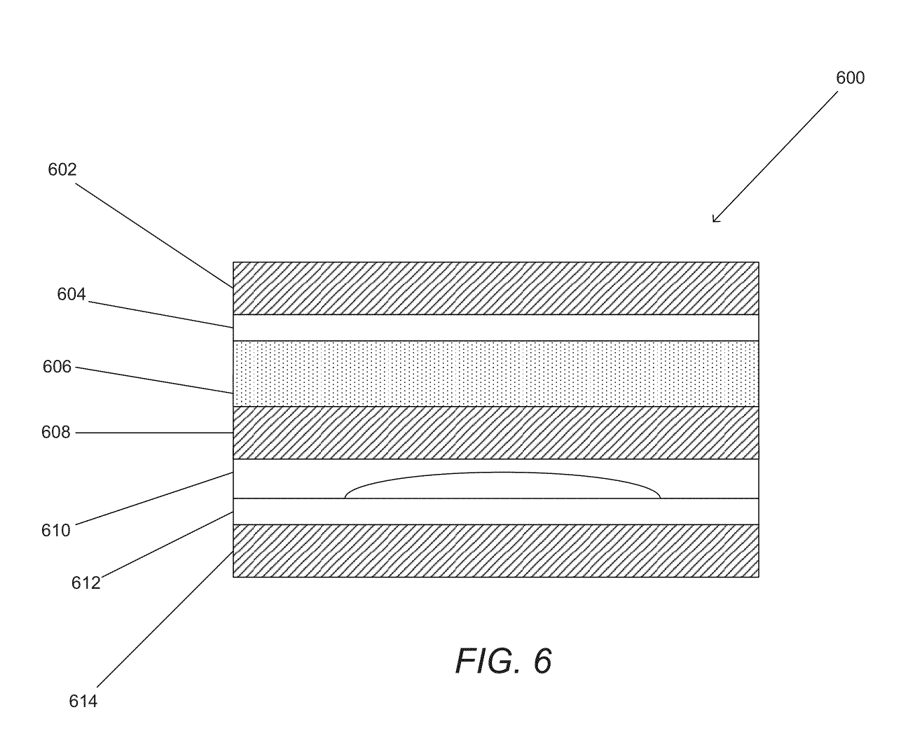

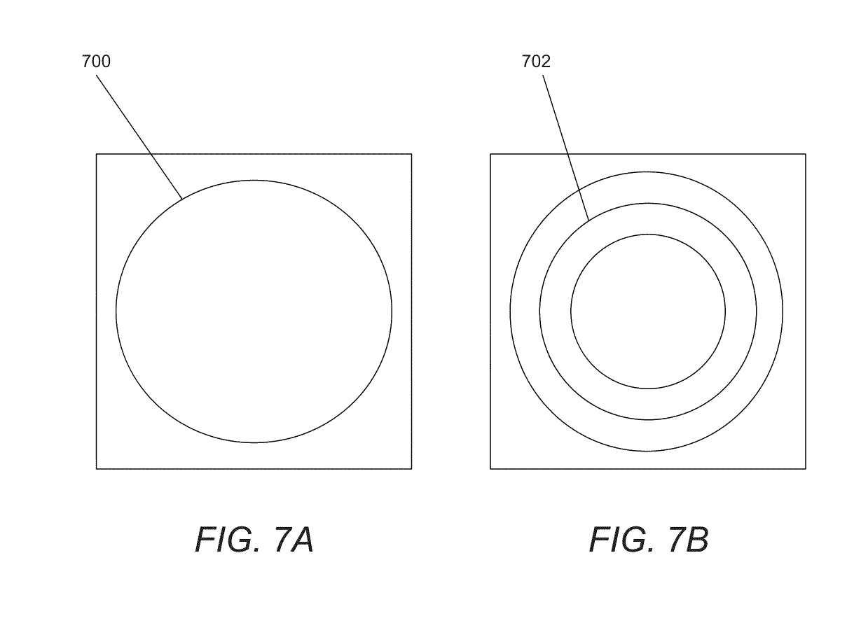

A liquid crystal adaptive optical element that can be utilized in a lens stack array in accordance with an embodiment of the invention is illustrated in FIG. 6. The liquid crystal adaptive optical element 600 includes three glass substrates 602, 608 and 614. An electrode 604 is formed on the interior surface of the first glass substrate 602 and a layer of liquid crystals 606 is located between the electrode and the second glass substrate 608. A second electrode 612 is formed on the interior surface of the third glass substrate 614, and a shaping layer 610 is located between the second electrode 612 and the second glass substrate 608. In the illustrated embodiment, the electrodes are configured to generate a uniform electric field. The shaping layer, however, includes two different materials having the same refractive index, but different dielectric properties. In this way, the shaping layer shapes the uniform electric field generated by the electrode. In several embodiments, the shaping layer creates a radially varying electric field within the liquid crystal layer resulting in a radially varying orientation of the liquid crystals. When the materials in the shaping layer are configured/shaped correctly, the single voltage applied to the electrodes can be controlled so that the differential rotation of the liquid crystal elements can be changed to differently focus light passing through the adaptive optical element. The increase in refractive power that can be achieved by increasing the voltage applied to the electrodes is conceptually illustrated in FIGS. 7A and 7B. The contour lines 700 shown in FIG. 7A indicate the refractive power distribution of the adaptive optical element, which have a circular symmetric arrangement due to the circular symmetric shape of the materials having different dielectric properties within the shaping layer of the adaptive optical element. As the voltage between the electrodes is increased (as shown in FIG. 7B), the number of contour lines 702 increases indicating an increase in refractive power. By controlling the voltage across the pair of electrodes in the adaptive optical element, an appropriate level of refractive power can be achieved.

The components of adaptive optical elements in accordance with embodiments of the invention may be sized to accommodate the relatively smaller lens elements (e.g. as compared to conventional, single optical channel cameras), and all things being equal, smaller adaptive optical elements may possess more beneficial optical properties. Moreover, the use of adaptive elements within array camera modules in accordance with embodiments of the invention is further advantageous insofar as the adaptive optical elements may only need to work over a narrower spectral band for its effects to be realized.

When a structure similar to the structure shown in FIG. 6 is incorporated into each of the optical channels in a lens stack array in accordance with embodiments of the invention, lens elements can be formed on the outer glass substrates 602, 614 using conventional processing techniques and manufacturing tolerances including (but not limited to) variance of the lens elements from their prescriptions and/or variation in the spacing of the lens stack array from the associated sensor in the assembled array camera module can be compensated for by tuning the electric fields applied to the layer of liquid crystals in one or more of the optical channels.

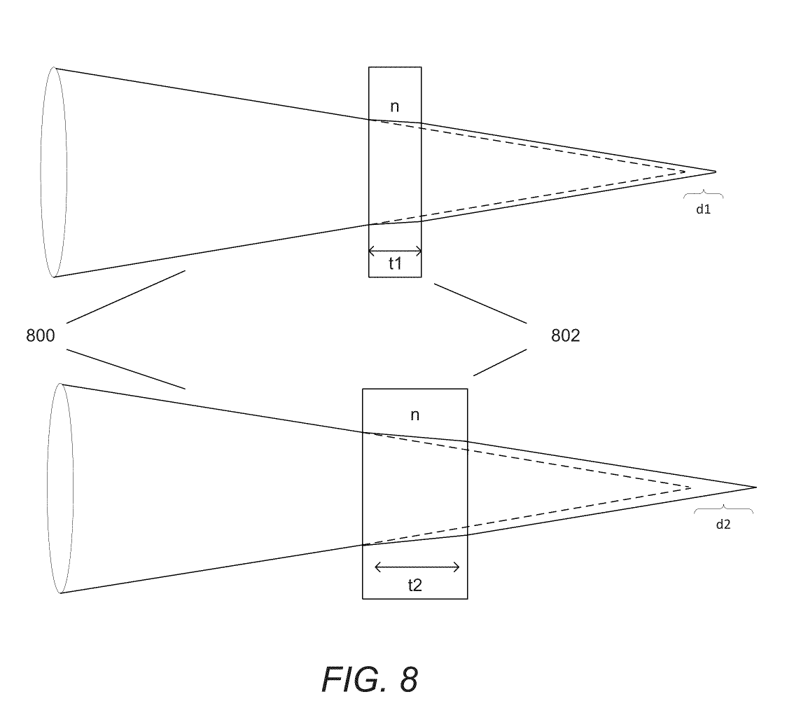

In many embodiments, the adaptive optical elements adjust focal length by varying their thickness. An adaptive optical element that varies its thickness to augment focal length in accordance with an embodiment of the invention is illustrated in FIG. 8. The adaptive optical element 800 includes a component 802 with an index of refraction n, and a capability of being able to modify its thickness, t. As one of ordinary skill in the art would appreciate, the component 802 augments the focal length by an amount d, in accordance with the relationship d≈((n−1)/n)*t. As one of ordinary skill in the art would appreciate, this equation assumes that the environment external to the component 802, has an index of refraction 1 (e.g. the index of refraction is that of air). FIG. 8 depicts the adjustment of the focal length: specifically, the dashed lines depict the light rays as they would be if unperturbed by the component 802, and the solid lines indicate the path the light rays traverse due to the component 802. When the adaptive optical element is at a thickness t1, the focal length shifts by an amount d1. When the adaptive optical element is at a greater thickness t2, the focal length shifts by a greater amount d2. In essence, by varying the thickness of the component 802, the adaptive optical element 800 can augment the focal distance of a lens stack. In many embodiments, adaptive optical elements that can vary their thickness are placed furthest from the aperture and closest to the sensor relative to other elements/lenses in a respective lens stack.

In a number of embodiments, adaptive optical elements are implemented by adjusting the axial positioning of lens elements within a lens stack. By controllably adjusting the axial positioning of lens elements within a lens stack, the image position of the respective lens stack, as well as other optical properties of the lens stack, may be controllably adjusted. In many embodiments, MEMS-based actuators are incorporated to adjust the axial positioning of lens elements within a lens stack. In several embodiments that incorporate MEMS-based actuators, the MEMS-based actuators are fabricated on a single piece of silicon, then singulated (diced) and then are integrated with the lens stack array in a hybrid manner. In many embodiments, MEMS-based actuator arrays could be fabricated as a (monolithic) array in a single piece of Silicon, and individual (and independently fabricated) lenslets are thereafter deposited into the actuators. Movement of those lenslets along the optical axis will provide similar focus change as the adaptive optical elements discussed in the current application. In some embodiments, only one lens out of each lens stack is moveable. In many embodiments, each lens element within a lens stack is moveable such that the entire lens stack may be repositioned. In a number of embodiments, VCM is incorporated within a lens stack to adjust the axial positioning of lens elements within a lens stack. Although MEMS-based actuators and VCM are specifically recited to adjust the axial position of lens elements within a lens stack, lens elements may be repositioned in any number of ways in accordance with embodiments of the invention.

In several embodiments, only certain of the lens stacks may have their respective lens elements be capable of being repositioned. In many embodiments all of the lens stacks may have their respective lens elements be capable of being repositioned.

Although specific adaptive optical elements are discussed above, any of a variety of adaptive optical elements that have controllable refractive power, can otherwise adjust focal length, or can otherwise alter the characteristics of the transmission of light through an optical channel and can be incorporated into a lens stack array can be utilized in accordance with embodiments of the invention. Additionally, adaptive optical elements may employ a combination of mechanisms, e.g. including MEMS systems and mechanically static components, to augment refractive power and/or otherwise control the flow of light in accordance with embodiments of the invention. Moreover, lens stacks within a lens stack array may employ different types of adaptive optical elements with respect to each other in accordance with embodiments of the invention. In some embodiments, adaptive optical elements are implemented within a lens stack array so as to allow it to magnify an image. In addition, in many embodiments, adaptive optical elements can controllably shift the centration of a refractive power distribution. When such an adaptive optical element is incorporated into a lens stack array in accordance with an embodiment of the invention, the adaptive optical element can controllably shift the central viewing direction of each optical channel to increase the sampling diversity in the images captured by the array camera module. The central viewing direction is the direction of the center of the field of view of a specific optical channel. Adaptive optical elements that can laterally shift the centration of a refractive power distribution in accordance with embodiments of the invention are discussed further below.

### Laterally Shifting Refractive Power Distributions

Adaptive optical elements can be incorporated into lens stacks within a lens stack array to introduce modifications in a variety of the characteristics of the optical channel including the focal length and the central viewing direction of the optical channel. In many embodiments, the adaptive optical elements control the central viewing direction of the optical channel by enabling control over the centration of the refractive power distribution of the respective adaptive optical element. When such an adaptive optical element is incorporated into a lens stack array, the angular sampling of the array camera module can be deterministically fine tuned by controlling the refractive power distribution of the adaptive optical element in each of the optical channels. Typically, when sampling diversity is increased greater resolution gains can be achieved using SR processing. In many embodiments, the extent of the adjustment of the central viewing direction is based on the object distance, at which optimum SR performance is achieved.

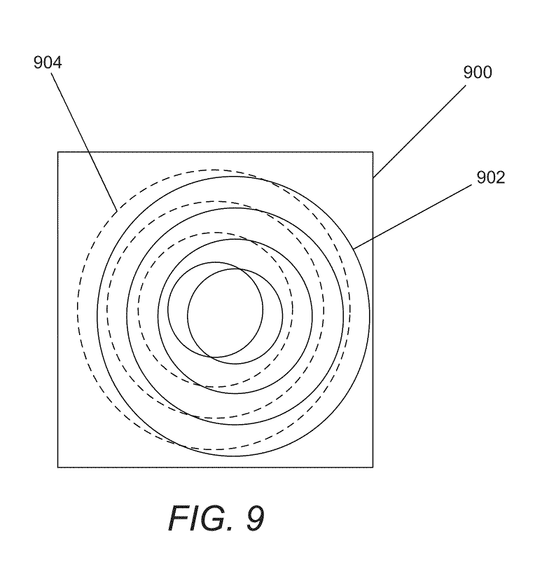

A shift in the centration of the refractive power distribution of an adaptive optical element in accordance with an embodiment of the invention is conceptually illustrated in FIG. 9. The adaptive optical element 900 is configured to generate a controllable refractive power distribution. The contours 904 shown in dashed lines show the location of the refractive power distribution when it is centered with respect to the optical channel. In the illustrated embodiment, the adaptive optical element includes the capability of laterally shifting the refractive power distribution. The solid contour lines 902 show the refractive power distribution of the adaptive element when laterally shifted so that the center of the refractive power distribution is laterally displaced from the central axis of the optical channel. As noted above, when an adaptive optical element similar to that shown in FIG. 9 is incorporated into a lens stack array in accordance with an embodiment of the invention the lateral displacement of the refractive power distribution in each optical channel can be controlled to fine tune the central viewing direction of each channel and thus increase the sampling diversity of the array camera.

In many embodiments, an initial set of images can be captured and the image processing pipeline can detect stacks of pixels when performing fusion of the pixels from the captured images. In the event that the number of stacks in at least a specific region of the image exceeds a threshold, the lateral shifts can be altered to increase sampling diversity in the captured images and a second set of images captured. In a number of embodiments, depth information from the captured images is utilized to determine an appropriate central viewing direction for each optical channel. The adaptive optical elements can be adjusted accordingly and a second set of images captured for use in the synthesis of a high resolution image. Although specific algorithms for enhancing sampling diversity are discussed above, any of a variety of algorithms can be utilized to increase sampling diversity using adaptive optical elements to deterministically control the central viewing direction of each optical channel in a lens stack array in accordance with embodiments of the invention. Various ways in which adaptive optical elements can control central viewing directions are discussed below.

### Using MEMS Systems Incorporating Piezo Elements to Control Central Viewing Direction

Adaptive optical elements similar to the optical element shown in FIGS. 5A and 5B can be configured to be capable of controlling the central viewing direction in accordance with embodiments of the invention. In many embodiments, a plurality of piezo elements are attached to a glass membrane, and the piezo elements can be individually activated so as to deflect the glass membrane in any number of ways. Thus, by controllably deflecting the glass membrane, the central viewing direction may be augmented as desired. Note that any number of piezo elements and any number of activation patterns may be used in accordance with embodiments of the invention.

Adaptive optical elements that utilize mechanically static components may also be used to control central viewing direction. Various electrode configurations for achieving lateral shifts in the refractive power distribution of adaptive optical elements that utilize liquid crystals to create a refractive power distribution in accordance with embodiments of the invention are discussed below.

### Adaptive Optical Element Electrode Configurations

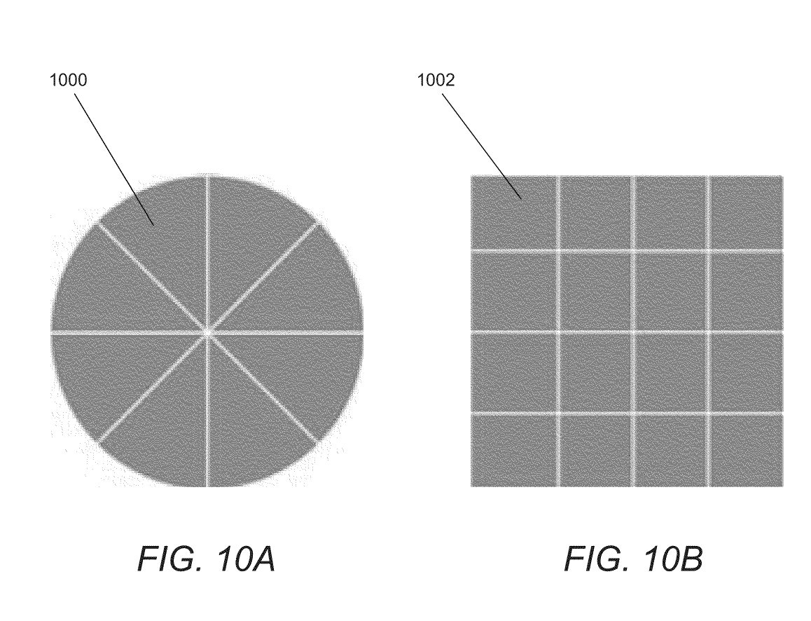

Adaptive optical elements similar to the adaptive optical element shown in FIG. 5 can utilize appropriate electrode configurations to control the centration of the refractive power distribution of the adaptive optical element. Electrode configurations to which voltages or voltage patterns can be selectively applied to alter the centration of the refractive power distribution of an adaptive optical element in accordance with embodiments of the invention are illustrated in FIGS. 10A and 10B. The electrode configuration shown in FIG. 10A is an azimuthally segmented electrode pattern where different voltages can be applied to the different segments 1000 to allow for lateral shifts in the center of the electric field generated by the electrodes, which in turn results in a shift of the center of the tunable LCD-lens optical phase function. The radially symmetrical electrode pattern limits the distortion to the phase function when laterally shifted. In other embodiments, however, electrode patterns including patterns that are not radially symmetrical can also be utilized. A grid electrode pattern is illustrated in FIG. 10B. Separate voltages can be applied to the segments 1002 of the grid electrode pattern to achieve a desired tunable electric field pattern.

Shaping Electric Fields without a Shaping Layer

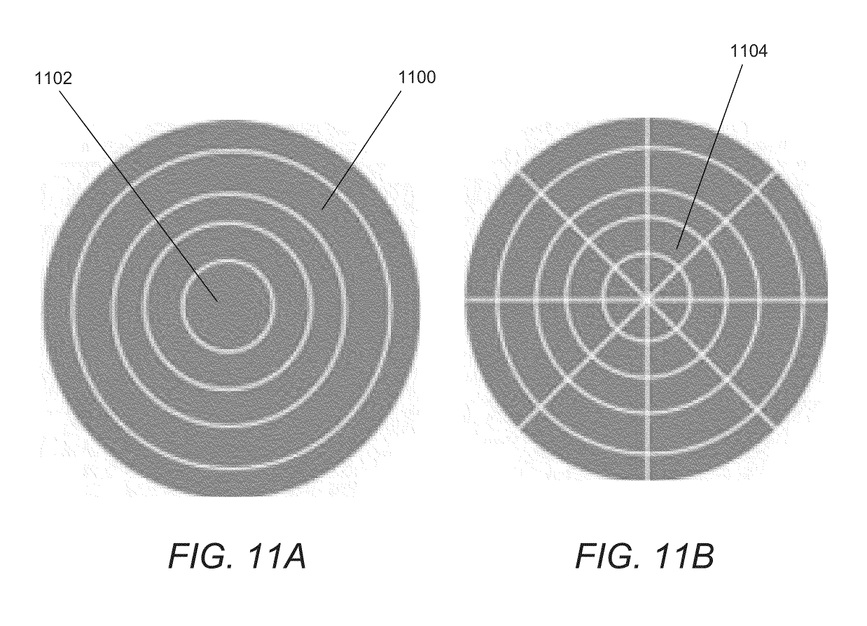

Referring back to FIG. 6, a shaping layer is included in the LCD-based adaptive optical element to shape a radially symmetric electric field using a single homogeneous electrode. The shaping layer defines the refractive power distribution of the adaptive optical element in the presence of a given electric field. Instead of utilizing a shaping layer, appropriate voltages can be applied to a set of electrodes to create variations in the electric field that are equivalent to the shaping applied by a shaping later. A set of electrodes that can be utilized in an adaptive optical element to generate a radially varying electric field to control the refractive power distribution of the adaptive optical element is conceptually illustrated in FIG. 11A. Concentric ring electrodes 1100 surround a central circular electrode 1102. Application of appropriate voltages to each of the electrodes can result in the set of electrodes creating a predetermined radially varying electric field.

In addition to utilizing a set of electrodes to generate a radially shaped electrode field, an appropriately configured set of electrodes can be utilized to introduce a lateral shift in the radially shaped electric field. An electrode configuration that can be configured to laterally shift the electric field generated by an adaptive optical element in accordance with an embodiment of the invention is conceptually illustrated in FIG. 11B. The electrodes are similar to the electrodes shown in FIG. 11A with the exception that the concentric rings and the central circular electrode are segmented azimuthally 1104 in a radially symmetric electrode pattern. Voltages need not only be applied to create a radially varying electric field but can also be utilized to introduce a shift in the centration of the radially varying refractive power distribution of the adaptive optical element.

While several electrode patterns are described above, any of a variety of electrode patterns can be utilized to control the electric field produced within an adaptive optical element in accordance with embodiments of the invention. For example, an electrode pattern can be used in which rings of different widths and/or having different spacing between the rings is utilized to radially vary the electric field. Accordingly, the set of electrodes that can be utilized in an adaptive optical element incorporated within an optical channel of a lens stack array in accordance with embodiments of the invention is only limited by the requirements of a specific application.

Additionally, while the above discussion has focused on using adaptive optical elements in the context of adjusting focal length and centration, adaptive optical elements can be employed to augment any number of lens stack characteristics in any number of ways including accounting for color adaptation and thermal variation. Adaptive optical elements that used for purposes other augmenting focal length and centration are discussed below.

Adaptive Optical Elements For Purposes other than Focal Length Adjustment And Centration

Adaptive optical elements may be incorporated in lens stacks to augment them in any number of ways in accordance with embodiments of the invention. In many embodiments, adaptive optical elements can provide color adaptation capabilities. Specifically, the adaptive optical elements may be configured such that they provide for color-specific focusing (e.g. specifically sensitive to either red, green or blue light). Thus, in many embodiments, each lens stack of a lens stack array is fitted with an adaptive optical element that is specifically sensitive to either red, green, or blue light, such that π filter groups are implemented on the lens stack array by the adaptive optical elements.

In several embodiments, the adaptive optical elements are configured to be able to counteract any adverse thermal effects that may be affecting the lens stack array. For example, in many embodiments, the adaptive optical elements may be configured to counteract adverse effects due to changes of refractive index of the lens material with temperature and/or due to thermal expansion that the array camera module may encounter. Additionally, the adaptive optical elements may be configured to augment the image so as to counteract the effect of the sensor's thermal signature on the image. In many embodiments, dark current measurements are used to measure temperature, and the adaptive optical elements are adapted accordingly.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed:

1. An array camera module comprising:
a lens stack array comprising at least two lens stacks, where at least one lens stack comprises an adaptive optical element that can adjust the characteristics of the transmission of light in the optical channel defined by the corresponding lens stack in response to at least one electrical signal;
a sensor comprising a focal plane for each lens stack within the lens stack array, where each focal plane comprises a plurality of rows of pixels that also form a plurality of columns of pixels and each focal plane is contained within a region of the sensor that does not contain pixels from another focal plane; and
circuitry configured to control at least one adaptive optical element;
wherein the lens stack array and the sensor are configured so that each lens stack can form an image on a corresponding focal plane.

2. The array camera module of claim 1, wherein the circuitry is configured to control at least one adaptive optical element based on at least one electrical signal generated by the sensor.

3. The array camera module of claim 2, wherein each of the lens stacks within the lens stack array comprises at least one adaptive optical element.

4. The array camera module of claim 3, wherein at least one adaptive optical element is configured to adjust the focal length of its corresponding lens stack.

5. The array camera module of claim 4, wherein the at least one adaptive optical element is configured to adjust the focal length of its corresponding lens stack so that its focal length is aligned with its corresponding focal plane.

6. The array camera module of claim 5, wherein the at least one adaptive optical element that is configured to adjust the focal length of its corresponding lens stack, comprises at least one piezo element, wherein the activation of the at least one piezo element causes the adaptive optical element to adjust the focal length of its corresponding lens stack.

7. The array camera module of claim 6, wherein the at least one adaptive optical element that is configured to adjust the focal length of its corresponding lens stack, further comprises:
a glass support, a polymer layer, and a thin glass membrane;
wherein the glass support is disposed adjacent to one side of the polymer layer, and the thin glass membrane is disposed adjacent to a second opposite side of the polymer layer; and
wherein the at least one piezo element is coupled to the glass membrane such that activation of the piezo element deflects the thin glass membrane such that the focal length of the corresponding lens stack is controllably adjusted.

8. The array camera module of claim 5, wherein the adaptive optical element comprises a liquid crystal layer that comprises liquid crystal elements.

9. The array camera module of claim 8, wherein the adaptive optical element further comprises:
a first glass substrate, a second glass substrate, a third glass substrate, a first electrode, a second electrode, and a shaping layer;
wherein the shaping layer comprises two different materials that have the same refractive index, but different dielectric properties;
wherein the first electrode is disposed adjacent to and in between the first glass substrate and the liquid crystal layer;
wherein the liquid crystal layer is disposed adjacent to and in between the first electrode and the second glass substrate;
wherein the second glass substrate is disposed adjacent to and in between the liquid crystal layer and the shaping layer;
wherein the shaping layer is disposed adjacent to and in between the second glass substrate and the second electrode;
wherein the second electrode is disposed adjacent to and in between the shaping layer and the third glass substrate; and
wherein the first electrode and the second electrode are configured such that when a potential difference is applied across the first electrode and the second electrode, the potential difference causes a differential rotation of the liquid crystal elements so as to adjust the lens stack's focal length.

10. The array camera module of claim 8, wherein the adaptive optical element further comprises a plurality of electrodes, configured to generate an electric field, the magnitude of which varies as a function of the radial position with respect to the corresponding lens stack.

11. The array camera module of claim 4, wherein the adaptive optical element is configured to adjust focal length by varying its thickness.

12. The array camera module of claim 4, wherein the adaptive optical element is configured to adjust image postion by varying the axial position of at least one lens element within a respective lens stack.

13. The array camera module of claim 12, wherein the adaptive optical element comprises at least one MEMS-based actuator for varying the axial position of at least one lens element within a respective lens stack.

14. The array camera module of claim 13, wherein the adaptive optical element is further configured to magnify an image.

15. The array camera module of claim 12, wherein the adaptive optical element comprises at least one VCM for varying the axial position of at least one lens element within a respective lens stack.

16. The array camera module of claim 3, wherein at least one of the adaptive optical elements is configured to adjust the central viewing angle of its corresponding lens stack.

17. The array camera module of claim 16, wherein the at least one adaptive optical element is configured to adjust the central viewing angle of its corresponding lens stack so as to increase the angular sampling of the images diversity provided by the focal planes.

18. The array camera module of claim 17, wherein the at least one adaptive optical element comprises a plurality of electrodes that are configured to control the centration of the refractive power distribution of the adaptive optical element.

19. The array camera module of claim 18, wherein the electrodes are arranged in an azimuthally segmented pattern such that a potential difference may be selectively applied across a subset of the electrodes thereby controlling the centration of the refractive power distribution of the adaptive optical element.

20. The array camera module of claim 17, wherein the extent of the adjustment of the central viewing angle is based on the distance of the object, relative to the camera, the image of which the focal planes are capturing.

21. The array camera module of claim 3, wherein at least one of the adaptive optical elements is configured to provide color adaptation capabilities.

22. The array camera module of claim 21, wherein the at least one adaptive optical element is configured to provide color-specific focusing.

23. The array camera module of claim 22, wherein:
all the adaptive optical elements provide for color-specific focusing;
the colors that are specifically focused are selected from the group consisting of: red, blue, and green; and
the adaptive optical elements with color-specific focusing are configured to implement π filter groups on the lens stack array.

24. The array camera module of claim 1, further comprising:
at least one measuring device configured to measure at least one physical parameter;
wherein the circuitry is configured to control at least one adaptive optical element based on the at least one physical parameter measured by the measuring device.

25. The array camera module of claim 24, wherein:
at least one measuring device is configured to measure temperature and generate at least one electrical signal indicative of the temperature measurement; and
the circuitry is configured to control the adaptive optical element based on the at least one electrical signal indicative of the temperature measurement generated by the at least one measuring device.

26. The array camera module of claim 1, wherein the circuitry is configured to control at least one adaptive optical element based on at least one electrical signal generated by a controller.

27. An array camera module comprising:
a lens stack array comprising at least two lens stacks, where each lens stack comprises an adaptive optical element that can adjust the characteristics of the transmission of light in the optical channel defined by the corresponding lens stack in response to an electrical signal and each adaptive optical element includes a liquid crystal layer and a plurality of electrodes that can generate an electric field, the magnitude of which varies as a function of radial and circumferential position with respect to the lens stack, such that the lens stack's focal length and central viewing direction can be adjusted;
a sensor comprising a focal plane for each lens stack within the lens stack array, where each focal plane comprises a plurality of rows of pixels that also form a plurality of columns of pixels and each focal plane is contained within a region of the sensor that does not contain pixels from another focal plane; and
circuitry configured to control at least one adaptive optical element based on at least one electrical signal generated by the sensor;
wherein the lens stack array and the sensor are configured so that each lens stack can form an image on a corresponding focal plane.
